(19) United States
(12) Patent Application Publication
(10) Pub. No.: US 2026/0001802 A1
(43) Pub. Date: Jan. 1, 2026

(54) STRENGTHENED GLASS-BASED ARTICLE

(71) Applicant: CORNING INCORPORATED, CORNING, NY (US)

(72) Inventors: Emily Marie Aaldenberg, Corning, NY (US); Timothy Michael Gross, Painted Post, NY (US)

(21) Appl. No.: 19/132,220

(22) PCT Filed: Dec. 5, 2023
(86) PCT No.: PCT/US2023/082407

§ 371 Date: May 22, 2025

Related U.S. Application Data
(60) Provisional application No. 63/431,490, filed on Dec. 9, 2022.

(51) Int. Cl. C03B 23/203; B32B 17/06; C03B 27/012

(52) U.S. Cl. CPC C03B 23/203; B32B 17/06; C03B 27/012

(57) ABSTRACT

A method of making a strengthened glass-based article includes compressing a cladding bonded to a glass at least in part by compacting the glass from a first density to a second density at least 10 mg/cm³ greater than the first density, where the compacting occurs when heating the glass to a temperature greater than 100° C. and below a softening temperature of the glass, whereby the compacted glass pulls the cladding into compression, thereby strengthening the glass-based article.

### CROSS-REFERENCE TO RELATED APPLICATIONS

This application claims the benefit of priority under 35 U.S.C. § 119 of U.S. Provisional Application No. 63/431,490 filed Dec. 9, 2022, the content of which is incorporated herein by reference in its entirety.

### BACKGROUND

Aspects of the present disclosure generally relate to a glass-based articles, such as glass sheets, laminates including glass layers, glass containers. More specifically, the present disclosure relates to strengthened glass-based articles having a cladding or portion thereof pulled into compression by a glass portion of the articles.

Glass articles may be strengthened in various ways, such as by thermal tempering, chemical tempering (so-called “ion exchanged”), and by taking advantage of differences in thermal expansion characteristics of different glasses in a glass-to-glass laminate, for example. Each strengthening process has uses and disadvantages in certain contexts. For example, thermal tempering may be useful for thick sheets of glass but may be difficult to achieve in thinner sheets. Chemical tempering can be time and resource consuming and may be limited to certain glass compositions, such as those that can facilitate ion-exchange in a salt bath. Glasses of glass-to-glass laminates may be selected so that a first of the glasses expands more at molten temperatures than a second of the glasses, where when the glasses cool, the first glass contracts more than the second and puts the second into compression. Such glass-to-glass laminates may be difficult to machine when cooled because of the internal stresses, where cracks to the first glass (in tension) may be catastrophic.

A need exists for another way to strengthen a glass-based article that overcomes some or all of the above-described challenges.

### SUMMARY

Applicants discovered a new way to strengthen glass-based articles. The technique can be implemented after the articles are manufactured, handled, and machined so that such processing can occur while the articles are in a lower stress state. Further, the technique can be implemented in a controlled manner to fine-tune the amount of stress imparted to the glass-based articles. The fine-tuning can allow for compressive stresses in a cladding of the articles to be just under a frangibility limit.

According to an Aspect A1, a method of making a strengthened glass-based article includes compressing a cladding bonded to a glass at least in part by compacting the glass from a first density to a second density at least 10 mg/cm³ greater than the first density. The compacting occurs when heating the glass to a temperature greater than 100° C. and below a softening temperature of the glass, whereby the compacted glass pulls the cladding into compression, thereby strengthening the glass-based article.

According to an Aspect A2, the Aspect A1 further includes cutting the glass-based article prior to the compacting.

According to an Aspect A3, the Aspect A1 further includes polishing at least a portion of the glass-based article prior to the compacting.

According to an Aspect A4, the temperature of the Aspect A1 is above 200° C.

According to an Aspect A5, the compacting of Aspect A4 further comprises keeping the glass at or above the temperature for at least an hour in aggregate.

According to an Aspect A6, prior to the heating of Aspect A4 the glass is below 50° C.

According to an Aspect A7, the glass of Aspect A1 is a first glass portion, and wherein the cladding is a second glass portion.

According to an Aspect A8, the first and second glass portions of Aspect A7 have different compositions, and glass of the first glass portion comprises at least 5 mol % less SiO₂ than glass of the second glass portion.

According to an Aspect A9, the glass of the first glass portion of Aspect A8 comprises more B₂O₃ than the glass of the second glass portion.

According to an Aspect A10, the second glass portion of Aspect A7 is fused directly to the first glass portion.

According to an Aspect A11, wherein the first glass portion of Aspect A10 is interior to second glass portion such that the second glass portion overlays at least two opposing sides of the first glass portion.

According to an Aspect A12, glass of the first glass portion of Aspect A7 is at a lower fictive temperature than glass of the second glass portion.

According to an Aspect B1, a method of making a strengthened glass-based article includes rapidly cooling molten glass, bonding the glass to a cladding, heating the glass to a temperature greater than 100° C. and below a softening temperature of the glass, while bonded to the cladding, to increase density of the glass by at least 10 mg/cm³, and imparting compressive stress on the cladding during heating by compacting the glass bonded thereto, pulling the cladding into compression.

According to an Aspect B2, the rapidly cooling of Aspect B1 is such that temperature of the molten glass decreases by at least 300° C. in less than 2 minutes.

According to an Aspect B3, wherein the rapidly cooling of Aspect B1 is such that the molten glass, once solidified, has a fictive temperature of at least 600° C.

According to an Aspect B4, wherein the temperature of Aspect B1 is above 200° C.

According to an Aspect B5, wherein the compacting of Aspect B4 further comprises keeping the glass at or above the temperature for at least an hour in aggregate.

According to an Aspect B6, prior to the heating of Aspect B4 the glass is below 50° C.

According to an Aspect C1, a glass-based article includes a glass portion and a cladding, where the glass portion compresses the cladding. Glass of the glass portion is such that decrease in fictive temperature from 600° C. to 450° C. increases density thereof by at least 15 mg/cm³. The glass of the glass portion has fictive temperature less than 300° C. less than a softening temperature of the glass.

According to an Aspect C2, the glass portion of Aspect C1 is a first glass portion and the cladding is a second glass portion fused directly to the first glass portion.

According to an Aspect C3, wherein the first and second glass portions of Aspect C2 have different compositions, and wherein glass of the first glass portion comprises at least 5 mol % less SiO₂ than glass of the second glass portion.

According to an Aspect C4, the glass of the first glass portion of Aspect C3 comprises more B₂O₃ than the glass of the second glass portion.

According to an Aspect C5, glass of the first glass portion of Aspect C2 has a lower fictive temperature than the glass of the second glass portion.

According to an Aspect C6, the glass of the second glass portion of Aspect C2 is such that decrease in fictive temperature from 600° C. to 450° C. increases density thereof by less than 10 mg/cm³.

According to an Aspect D1, a glass-based article includes a first glass portion and a second glass portion bonded directly to the first glass portion. The article has stored compressive capacity such that if the first glass portion is heated to 400° C. for 1 hour and then cooled to 25° C., compressive stress in the second glass portion increases.

According to an Aspect E1, a glass-to-glass laminate includes a first glass portion, where glass of the first glass portion has a fictive temperature above 600° C., and a second glass portion fused to the first glass portion. The laminate has stored compressive capacity such that if the glass-to-glass laminate is heated-treated at 400° C. for 24 hours in standard atmosphere and sea level pressure, the glass of the first glass portion shrinks in volume more than twice as much as the glass of the second glass portion.

According to an Aspect E2, glass of the second glass portion of Aspect E1 has more silica than glass of the first glass portion.

According to an Aspect E3, glass of the first glass portion of Aspect E1 has more boria than glass of the second glass portion.

According to an Aspect E4, if the glass-to-glass laminate of Aspect E1 is heated-treated at 400° C. for 24 hours in standard atmosphere and sea level pressure, the glass of the first glass portion shrinks in volume more than three-times as much as the glass of the second glass portion.

According to an Aspect F1, a glass-to-glass laminate includes a first glass portion and a second glass portion fused to the first glass portion. Glass of the second glass portion has the same composition as glass of the first glass portion but a fictive temperature less than the glass of the first glass portion by at least 200° C. The laminate has stored compressive capacity such that if the glass-to-glass laminate is heated-treated at 400° C. for 24 hours in standard atmosphere and sea level pressure, the glass of the first glass portion shrinks in volume more than the glass of the second glass portion.

Additional features and advantages are set forth in the detailed description that follows, and in part will be readily apparent to those skilled in the art from the description or recognized by practicing the technology as described in the written description and claims hereof, as well as the appended drawings. It is to be understood that both the foregoing general description and the following detailed description are merely exemplary and are intended to provide an overview or framework to understand the nature and character of the claims.

### BRIEF DESCRIPTION OF THE FIGURES

The accompanying figures are included to provide a further understanding and are incorporated in and constitute a part of this specification. The drawings of the figures illustrate one or more aspects of the present disclosure, and together with the detailed description explain principles and operations of the various aspects. As such, the disclosure will become more fully understood from the following detailed description, taken in conjunction with the accompanying figures, in which:

FIG. 1 is a side view of an article in the form of a glass-to-glass laminate, according to an aspect of the present disclosure.

FIG. 2 is a side sectional view of another article, according to an aspect of the present disclosure.

FIG. 3 is a side sectional view of yet another article, according to an aspect of the present disclosure.

FIG. 4 is a side sectional view of still another article, according to an aspect of the present disclosure.

FIG. 5 is a plot of density versus fictive temperature for different glasses.

FIG. 6A is a plot of temperature versus time for a heat treatment.

FIG. 6B is change in length over initial length versus time for four glass samples of the same composition but of different initial fictive temperatures undergoing the heat treatment of FIG. 6A.

FIG. 7 is a digital image of an article, according to an aspect of the present disclosure.

FIG. 8 is a plot of change in Young's modulus as a function of temperature for glasses of the article of FIG. 7.

FIG. 9 is a plot of ratio of stress in the clad glass relative to the initial stress as a function of time in five different heat-treatments.

### DETAILED DESCRIPTION

Before turning to the following detailed description and figures, which illustrate aspects of the present disclosure in detail, it should be understood that the present inventive technology is not limited to the details or methodology set forth in the detailed description or illustrated in the figures. For example, as will be understood by those of ordinary skill in the art, features and attributes associated with an aspect shown in one of the figures or described in the text relating to an aspect may be applied to another aspect shown in another of the figures or described elsewhere in the text.

Applicants have discovered that glass compressive stress, such as in a glass cladding of a glass-to-glass laminate, can be increased through thermal treatment, after the glass-to-glass laminate is formed, by heat-treatment of the laminate at temperatures below an annealing range of the glasses of the glass-to-glass laminate. More specifically, this increase in compressive stress may be achieved by imparting greater shrinkage of a core glass relative to the cladding glass, where the shrinkage is due to a change of density of each glass layer, which may vary for glasses as disclosed herein due to thermal history, similar to other so-called “fictive” properties of the glass. The ability to change the compressive stress in the laminate after forming, and in a controlled manner, allows for cutting/machining of the glass before stresses are raised and thereby increasing yield and lowering risks of inadvertent fracture during such processing.

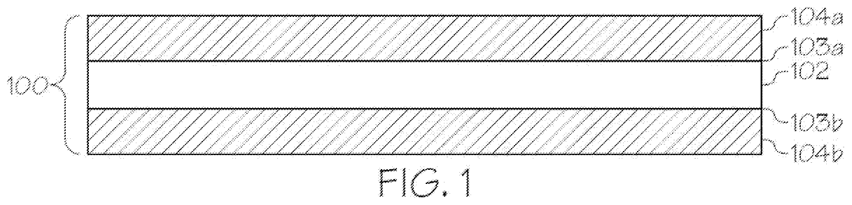

Referring to FIG. 1, a glass-based article 100 includes a glass portion 102 and a cladding 104a, 104b. The glass portion 102 is coupled to the cladding 104a, 104b, such as directly bonded (e.g., adhered, fixed, fused i.e. joined by melting together) thereto at an interface 103a, 103b. According to an aspect of the present disclosure, after bonding to the cladding 104a, 104b, the glass portion 102 has compacted from a prior (lesser) density to a greater density, and now pulls the cladding 104a, 104b into compression, thus strengthening the glass-based article 100. Alternatively, at an earlier state, the glass portion 102 may have capacity to compact from the lesser density to the higher density. For example, in one state, the glass portion 102 may be less dense, or solidified slightly expanded; then once compacted, the glass portion 102 may contract to a more dense state, pulling the cladding 104a, 104b into compression at the interface 103a, 103b, thus strengthening the glass-based article 100 by imputing the cladding 104a, 104b with corresponding resistance to cracking and fracture.

According to an aspect of the present disclosure, the glass portion 102 is more specifically a first glass portion 102, and the cladding 104a, 104b in FIG. 1 is a second glass portion 104a, 104b. Glass of the first glass portion 102 may differ from glass of the second glass portion 104a, 104b in terms of composition and/or density. For example, density of glass of the first glass portion 102 may have a greater dependency on thermal history of the glass than glass of the second glass portion 104a, 104b such that density of the glass of the first glass portion 102 may be increased more than that the glass of the second glass portion 104a, 104b when augmenting thermal history of combined article, as further explained herein. In other contemplated embodiments, the cladding 104a, 104b may be a ceramic, glass-ceramic, metal, or other solid material where the cladding 104a, 104b shrinks less when undergoing thermal treatment, as disclosed herein, than the glass portion 102.

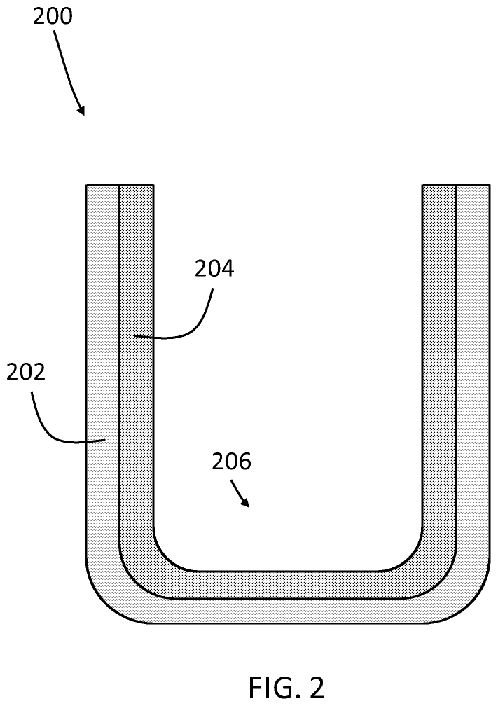

Referring to FIG. 2, another glass-based article 200 includes a glass portion 202 and a cladding 204. The glass portion 202 is coupled to the cladding 204, such as directly bonded (e.g., adhered, fixed, fused) thereto. According to an aspect of the present disclosure, the glass portion 202 has compacted from a prior (lesser) density to a greater density, and now pulls the cladding 204 into compression, thus strengthening the glass-based article 200.

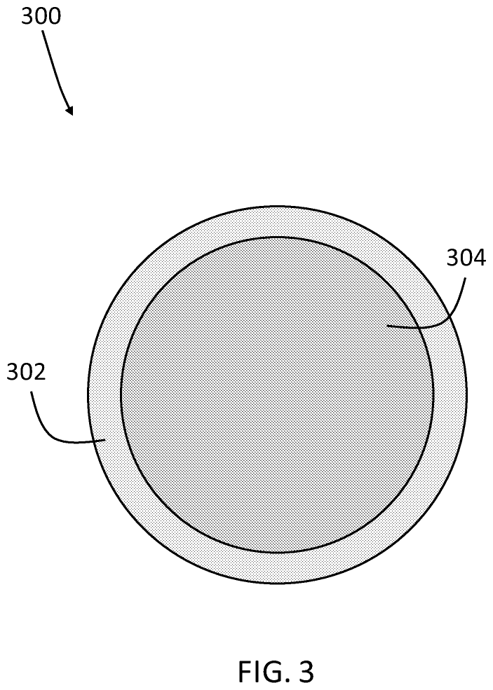

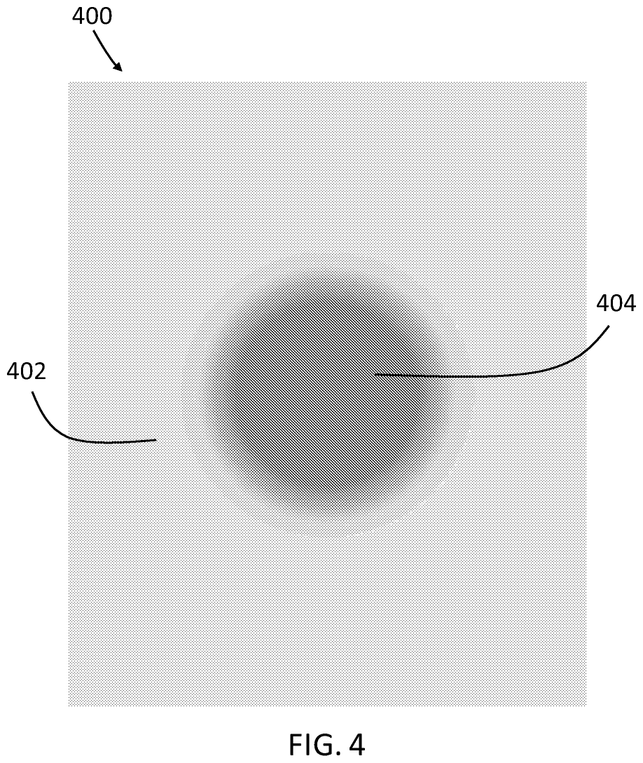

As shown in FIG. 2, the glass-based article 200 may have curvature, where the cladding 204 forms an exterior or outward facing portion of the glass-based article 200. For example, the glass-based article 200 may be a container shown in cross section in FIG. 2, where the cladding 204 forms an exterior surface of the container; or the glass-based article 200 may be a curved sheet, cover glass, window, partition, electronics housing, etc. where the cladding 204 form an outward-facing surface thereof. The cladding 204 may be glass and/or another material, such as a glass-ceramic, similar to cladding 104a, 104b of FIG. 1 and other aspects shown in FIGS. 3-4.

The cladding 204 of the article 200 is only on one side of the glass portion 202 in FIG. 2. As such, when the glass portion 202 compacts, the glass portion 202 may pull the cladding 204 into compression, and/or may also impart a bending force on the cladding 204, providing curvature to the article 200 with the glass-portion 202 forming a concave interior well 206. Where the article 200 is a container or receptacle, fluid, such as medicaments, may be stored in the well 206. The article 200 may also be capped and may have additional contours, such as a neck, rim, etc.

Referring now to FIG. 3, yet another glass-based article 300 includes a glass portion 302 and a cladding 304. The glass portion 302 is coupled to the cladding 304, such as directly bonded (e.g., adhered, fixed, fused) thereto. According to an aspect of the present disclosure, the glass portion 302 has compacted from a prior (lesser) density to a greater density, and now pulls the cladding 204 into compression, thus strengthening the glass-based article 200.

In FIG. 3, the cladding 304 fully surrounds the glass portion 302. For example, the article 300 of FIG. 3 may be a sphere, where glass portion 302 is a solid core the cladding 304 envelops the core on all sides. Alternatively, the glass portion 302 may be cylindrical, elongate rod, pill-shaped, etc. with the cladding surrounding at least a center region of such a geometry. Alternatively still, Applicants contemplate that the glass portion 302 may be tubular or a bubble having an open or hollow center, with the cladding forming an exterior layer, similar to the arrangement of the cladding in FIG. 3, surrounding an outside of such, or an interior layer, or both interior and exterior layers in such an arrangement.

As with the cladding 104a, 104b, 204 of articles 100, 200 of FIGS. 1-2, the glass portion 302 may be a first glass portion and the cladding 304 also include (e.g., be, mostly be, at least partially be) glass, and thus be characterized as a second glass portion of the article 300. According to an aspect of the present disclosure, the glass of the second glass portion may differ in composition from the glass of the first glass portion, as further discussed herein, where the glass of the second glass portion may respond differently to thermal treatment than the glass of the first glass portion, should both glass portions undergo the same thermal treatment together and coupled in the article 300. Alternatively, Applicants contemplate that the glass of the second glass portion may have the same composition as the glass of the first glass portion, but instead have a different density, as further explained with respect to article 400 of FIG. 4.

Referring to FIG. 4, the article 400 includes a glass portion 402 and a cladding 404. The glass portion 402 is coupled to the cladding 404, such as directly bonded (e.g., adhered, fixed, fused) thereto. More specifically, the article 400 is a single, continuous monolith, with a homogeneous glass composition continuously extending throughout the article 400, where the glass has high change in density as a function of thermal history or thermal treatment (e.g., >10 mg/cm³ over drop from 650 to 450° C. of fictive temperature, such as >15, >20, >25, >30 mg/cm³ over drop from 650 to 450° C. of fictive temperature). As shown in FIG. 4, the article 400 may be arranged as sheet, or the article may be otherwise arranged (e.g., container, tube).

According to an aspect of the present disclosure, the glass portion 402, a first portion of the glass, has compacted from a prior (lesser) density to a greater density, and now pulls the cladding 404, a second portion of the glass, into compression. The glass portion 402 may be compacted by locally heat treating the glass portion 402, such as with a laser but not heating the cladding 404, for example, such as by providing a heat sink to the cladding so that heating of the glass portion 402 does not transfer to the cladding 404 and compact the cladding.

Referring to articles 100, 200, 300, 400, Applicants discovered that stress (e.g., compression in the cladding 104a, 104b, 204, 304, 404 and corresponding tension in the glass portions 102, 202, 302, 402) can be increased through low temperature heat-treatment, below a glass transition temperature of the respective glass portions 102, 202, 302, 402. This process allows for glass of such articles 100, 200, 300, 400 to have low stress when the glass is formed, allowing for ease of processing (e.g., separation from a draw, edge finishing, transport, and other processes). Then, the glass can be subsequently heat-treated to increase the stress. Further, with this process, articles 100, 200, 300, 400 may have higher levels of stress or stored energy than is present at initial forming, such as off a fusion draw. This higher stress allows the articles 100, 200, 300, 400 to have better retained strength following damage introduction and can provide an alternative to ion-exchange to increase the compressive stress in the cladding 104a, 104b, 204, 304, 404, which may be at or near an exterior surface of the articles 100, 200, 300, 400. This process can also be combined with ion-exchange strengthening.

During the low-temperature heat-treatment (e.g., below a glass transition temperature of the respective glass portions; less than 600° C., such as less than 550° C., such as less than 500° C., such as less than 450° C., such as within 150° C. of 400° C., such as within 100° C. of 400° C., where heat-treatment in aggregate is for at least 30 minutes, such as at least 90 minutes, such as at least 60 minutes, such as at least 2 hours, such as at least 4 hours), the density of the glass portion 102, 202, 302, 402 and the cladding 104a, 104b, 204, 304, 404 will be increased from prior densities corresponding to higher fictive temperatures. Greater shrinkage of the glass portion 102, 202, 302, 402 than the cladding 104a, 104b, 204, 304, 404 during heat-treatment leads to an increase in the stress of the articles 100, 200, 300, 400.

Put another way, the articles 100, 200, 300, 400 may be assembled (e.g., fusion formed, bonded, welded, adhered) when the glass portion 102, 202, 302, 402 has a low density due to fast cooling rate of the glass of the glass portion 102, 202, 302, 402. Then, subsequent heat-treatment of the glass of the glass portion 102, 202, 302, 402 at temperatures below an annealing range of the glass of the glass portion 102, 202, 302, 402 causes an increase in density (and corresponding a reduction in fictive temperature) of the glass of the glass portion 102, 202, 302, 402, which leads to shrinkage (structural relaxation) of the glass portion 102, 202, 302, 402 relative to the cladding 104a, 104b, 204, 304, 404.

According to an aspect of the present disclosure, the articles 100, 200, 300, 400 may undergo the heat-treatment, and both the glass portion 102, 202, 302, 402 and the cladding 104a, 104b, 204, 304, 404 may experience similar temperatures, such as if the heat treatment is performed in a furnace, oven, lehr, etc. However, according to an aspect of the present disclosure, material of the cladding 104a, 104b, 204, 304, 404 shrinks less from the heat—treatment than the glass portion 102, 202, 302, 402, and is correspondingly pulled by the glass portion 102, 202, 302, 402 into compression. Further, as indicated above, the glass portion 102, 202, 302, 402 may be a first glass portion, and the cladding 104a, 104b, 204, 304, 404 may be also include glass and be a second glass portion of the respective articles 100, 200, 300, 400.

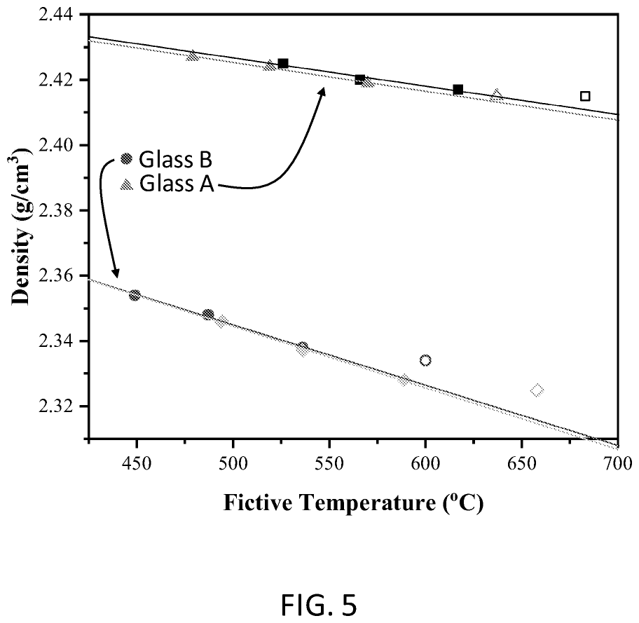

Referring now to FIG. 5, a plot shows density of glass as a function of fictive temperature, the frozen solid-state of the glass generally corresponding to how quickly the glass cooled, for example glass compositions A and B (see following Table 1 for compositions). As can be seen, between the fictive temperatures of about 450° C. and 650° C., the glass B has a change in density of about 35 mg/cm³, while glass A is about 7 mg/cm³.

TABLE 1

| mol % | A | B |
|---|---|---|
| SiO₂ | 72.43 | 66.53 |
| Al₂O₃ | 9.03 | 10.97 |
| B₂O₃ | | 9.74 |
| P₂O₅ | | |
| Li₂O | | 3.86 |
| Na₂O | 12.55 | 8.3 |
| K₂O | 3.89 | |
| MgO | 2 | 0.5 |
| SnO₂ | 0.1 | 0.1 |

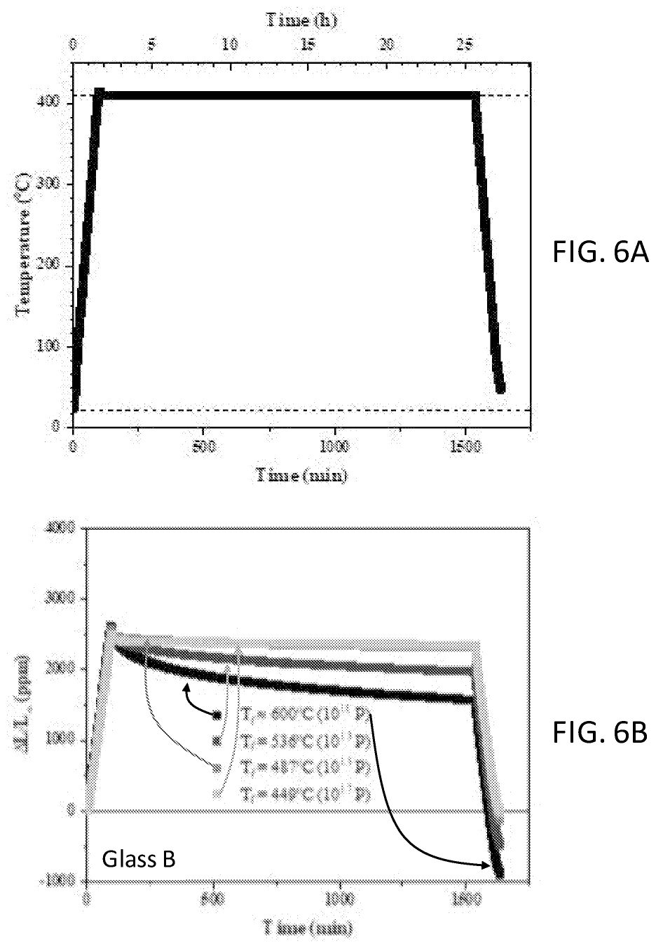

To further illustrate effect of fictive temperature on density of glass and how density can change by altering the fictive temperature through heat treatment, FIG. 6B shows glass B starting at 4 different fictive temperatures and how the samples shrink under the heat treatment cycle shown in FIG. 6A, where the Y-axis is change in length over initial length in parts per million. As temperature increases, each of the samples initially expands. However, the samples with the greater initial fictive temperatures (e.g., 600° C. and 536° C.) shrink significantly more than the samples with the lower initial fictive temperatures (e.g., 600° C. and 536° C.) after about 24 hours. Furthermore, once the heat treatment ends, the samples with greater initial fictive temperatures shrunk up to about 1000 ppm relative to their initial size.

Glasses A and B are an example of glasses that may be paired with one another, where if they are heat treated together and have the same starting fictive temperature, then they will shrink at different rates. However, Applicants believe that other glasses may be paired for this purpose according to general principles, as now explained.

First, Applicants find adding or increasing silica to a glass composition decreases the ability to alter properties of the respective glass related to fictive temperature, such as density, Young's modulus, refractive index, shear modulus, coefficient of thermal expansion. For example, Young's modulus in GPa of ternary glass with equal parts CaO and Al₂O₃ and 60 mol % SiO₂ changes by −0.0215 per degree Celsius of fictive temperature between 750° C. and 850° C. fictive temperature, while Young's modulus of ternary glass with equal parts CaO and Al₂O₃ but 80 mol % SiO₂ only changes by −0.001 per degree Celsius of fictive temperature over that same range. This relationship is also evidenced by glasses A and B, and slopes of the curves in FIG. 5 with respect to density.

According to an aspect of the present disclosure, for articles 100, 200, 300, 400 that are glass-to-glass laminates where the glass portion 102, 202, 302, 402 is a first glass portion and the cladding 104a, 104b, 204, 304, 404 is a second glass portion of a different glass composition than the first glass portion, the first glass portion (e.g., core; i.e. the more responsive glass in terms of change in density from change in fictive temperature) has less silica than the glass of the second glass portion, the cladding 104a, 104b, 204, 304, 404 of the articles 100, 200, 300, 400, such as where glass of the first glass portion has at least 3 mol % less silica than the glass of the second glass portion, such as at 5 mol % less, such as at least 8 mol % less, such as at least 10 mol % less. According to an aspect of the present disclosure, the glass of the glass portion 102, 202, 302, 402 is not pure silica, such as having less than 90 mol % silica, such as less than 80 mol %, such as less than 70 mol %, such as less than 60 mol % silica.

Similarly, Applicants find that substitution of boria (B₂O₃) for at least some silica (SiO₂) in glass compositions increases ability of the fictive-influenced glass properties (e.g., density, Young's modulus) to be altered by heat treatment reducing fictive temperature. For example, 0.15CaO·0.15Al₂O₃·(x)B₂O₃·(0.7−x)SiO₂ glass has a slope of −0.0317 change in Young's modulus (GPa) over change in fictive temperature (° C.) when x is 0.05, versus −0.0608 when x is 0.24, i.e. greater amount of B₂O₃ in place of SiO₂ when measured around 600° C. to 800° C. in fictive temperature.

According to an aspect of the present disclosure, for articles 100, 200, 300, 400 that are glass-to-glass laminates where the glass portion 102, 202, 302, 402 is a first glass portion and the cladding 104a, 104b, 204, 304, 404 is a second glass portion of a different glass composition than the first glass portion, the first glass portion has more boria than the glass of the second glass portion, the cladding 104a, 104b, 204, 304, 404 of the articles 100, 200, 300, 400, such as where glass of the first glass portion has at least 2 mol % more boria than the glass of the second glass portion, such as at 3 mol %, such as at least 5 mol %, such as at least 8 mol % more. According to an aspect of the present disclosure, the glass of the glass portion 102, 202, 302, 402 has at least some boria, such as at least 2 mol %, such as at least 3 mol %, such as at least 5 mol %, and/or no more than 35 mol %.

Also, as a general principle, Applicants find glass compositions using smaller (in terms of ionic radii) alkali metal species tend to have a greater ability to be frozen in a modified state and subsequently altered, so glass with lithium as a constituent has greater ability to be frozen in a modified state and subsequently altered than glass instead with sodium, and glass with sodium has greater ability than glass instead with potassium. For example, when R₂O is Li₂O of 20 mol % R₂O, 10 mol % Al₂O₃, 70 mol % SiO₂ glass, the glass has a slope of −0.0324 change in Young's modulus (GPa) over change in fictive temperature (° C.) when measured around 450° C. to 650° C. in fictive temperature. While when R₂O of such a glass is instead Na₂O, the slope is −0.0301; and when R₂O is K₂O, the slope is −0.0227.

According to an aspect of the present disclosure, for articles 100, 200, 300, 400 that are glass-to-glass laminates where the glass portion 102, 202, 302, 402 is a first glass portion and the cladding 104a, 104b, 204, 304, 404 is a second glass portion of a different glass composition than the first glass portion, the glass of the first glass portion has more smaller (in terms of ionic radii) alkali metal species than the second glass portion, such as more lithium than glass of the second glass portion, or the glass of the first glass portion has more Na₂O while the second glass portion has more K₂O.

However, Applicants also find that mixing of different alkali metals has the opposite effect, and that the impact of mixing of different alkali metals is not simply the average of glasses with lone alkali metal constituents. For example, when the R₂O is 10 mol % Li₂O and 10 mol % Na₂O of 20 mol % R₂O, 10 mol % Al₂O₃, 70 mol % SiO₂ glass, then the slope of change in Young's modulus (GPa) over change in fictive temperature (° C.) when measured around 450° C. to 650° C. in fictive temperature is −0.024, and when R₂O is 10 mol % Na₂O and 10 mol % K₂O, the slope is −0.0184.

According to an aspect of the present disclosure, for articles 100, 200, 300, 400 that are glass-to-glass laminates where the glass portion 102, 202, 302, 402 is a first glass portion and the cladding 104a, 104b, 204, 304, 404 is a second glass portion of a different glass composition than the first glass portion, the glass of the first glass portion has a mix of alkali metal oxides, such as at least 2 mol % of at least two different alkali metal oxides and/or as at least 3 different alkali metal oxides.

Regardless of the compositional choices to achieve the specific glass compositions in the glass portion 102, 202, 302, 402 of articles 100, 200, 300, 400, and glass of the cladding 104a, 104b, 204, 304, 404, if the cladding is glass, the glass of the glass portion 102, 202, 302, 402 should have a high ability to be frozen in a modified state (e.g., with a relatively low density) and subsequently altered (e.g., to shrink considerably). In terms of the curves in FIG. 5, the glass of the glass portion 102, 202, 302, 402 has a change in density (Δρ) over change in fictive temperature (ΔT_{f}) of at least 10 mg/200° C. over the fictive temperature range of 450 to 650° C., such as at least 15 mg/200° C., such as at least 20 mg/200° C., such as at least 25 mg/200° C., such as at least 30 mg/200° C. For articles 100, 200, 300, 400 where the cladding 104a, 104b, 204, 304, 404 is a second glass portion, glass of the second glass portion has a Δρ/ΔT_{f} over the fictive temperature range of 450 to 650° C. of less than that of the glass of the first glass portion, such as at least 10 mg/200° C. less, such as at least 15 mg/200° C. less, such as at least 20 mg/200° C. less, such as at least 25 mg/200° C. less.

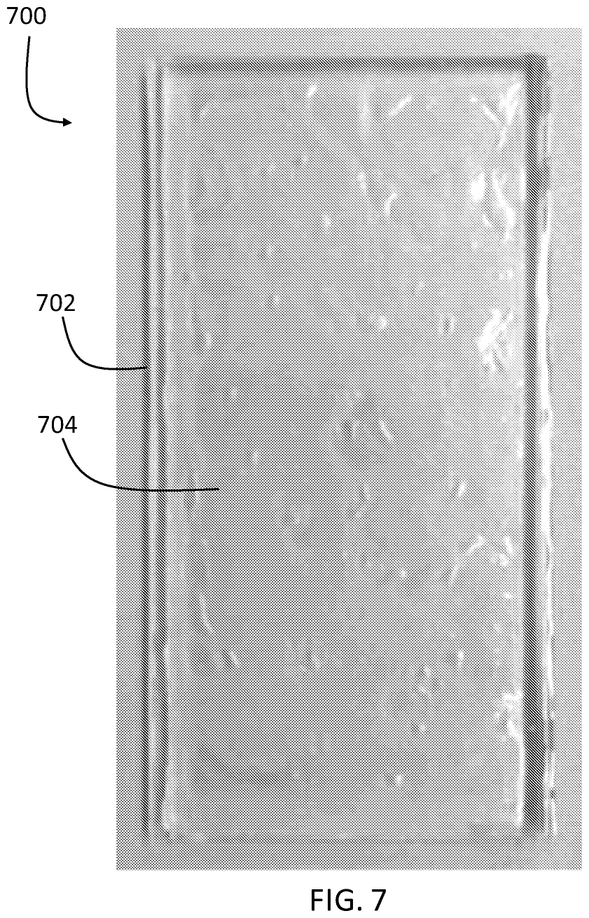

Referring to FIG. 7, a glass-to-glass laminate 700 includes a first glass portion 702 (“Core”) bonded to a second glass portion 704 (“Clad”). The laminate 700 was made by heat-treating a stack of Clad-Core-Clad glass at 929° C., the softening point of the Clad glass, for 10 minutes and subsequently cooling the laminate 700 quickly using fans in air. Each layer (i.e. Clad, Core, Clad glasses) of the laminate 700 was comprised of a 20×40×0.6 mm piece of glass with polished faces and precision saw-cut edges to prevent cracking upon cooling. The rapid cooling was used to set a high initial fictive temperature in the glasses of the glass laminate 700 (e.g., >600° C.). As may be apparent in FIG. 7, both types of glass are optically translucent and/or transparent (e.g., >60%/mm through thickness over 380-700 nm spectrum, such as >70%, such as >80%). The first and second glass portions 702, 704 are fused to one another. In terms of the articles 100, 200, 300, 400, in cases where the articles are glass-to-glass laminates, the glass portion 102, 202, 302, 402 or first glass portion may be the “Core” glass, and the cladding 104a, 104b, 204, 304, 404 or second glass portion may be the “Clad” glass. The particular arrangement in FIG. 7 is most similar to the article 100.

Compositions of the Core and Clad glasses of the laminate 700 are in Table 2 and conform to the above-described compositional principles, so density (and other fictive-related-properties) of the Core glass is more responsive to changes fictive temperature than the Clad glass.

TABLE 2

| mol % | Core | Clad |
|---|---|---|
| SiO₂ | 45.66 | 59.7 |
| Al₂O₃ | 15.04 | 15.06 |
| B₂O₃ | 23.5 | 14.8 |
| CaO | 15.38 | 10.12 |
| Na₂O | 0.06 | 0.05 |
| K₂O | 0.02 | 0.01 |
| MgO | 0.32 | 0.22 |
| Fe₂O₃ | 0.02 | 0.01 |
| Cl | 0.01 | 0.02 |

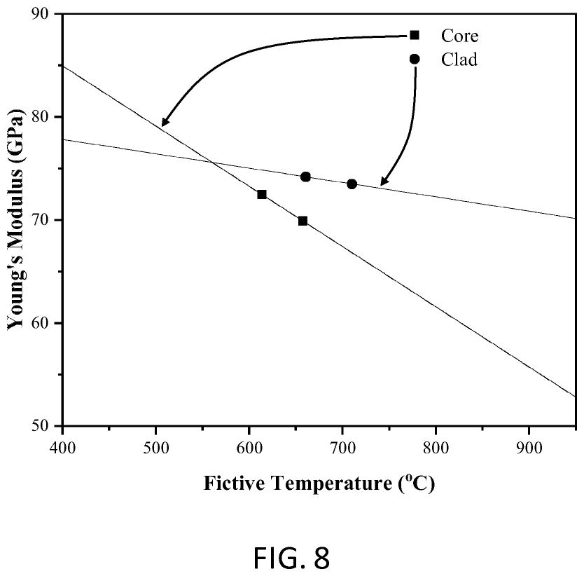

For example, FIG. 8 compares Young's modulus of the Core and Clad glasses at different temperatures, and the Core glass has a steeper slope. In terms of the curves in FIG. 8, the glass of the glass portion 102, 202, 302, 402 (e.g., Core glass) has a change in Young's modulus (ΔE) over change in fictive temperature (ΔT_{f}) of at least 4 GPa/150° C. over the fictive temperature range of 600 to 750° C., such as at least 6 GPa/150° C., such as at least 8 GPa/150° C., such as at least 10 GPa/150° C. For articles 100, 200, 300, 400 where the cladding 104a, 104b, 204, 304, 404 is a second glass portion (e.g., Clad glass), glass of the second glass portion has a ΔE/ΔT_{f} over the fictive temperature range of 600 to 750° C. of less than that of the glass of the first glass portion, such as at least 1 GPa/150° C. less, such as at least 2 GPa/150° C. less, such as at least 3 GPa/150° C. less, such as at least 5 GPa/150° C. less.

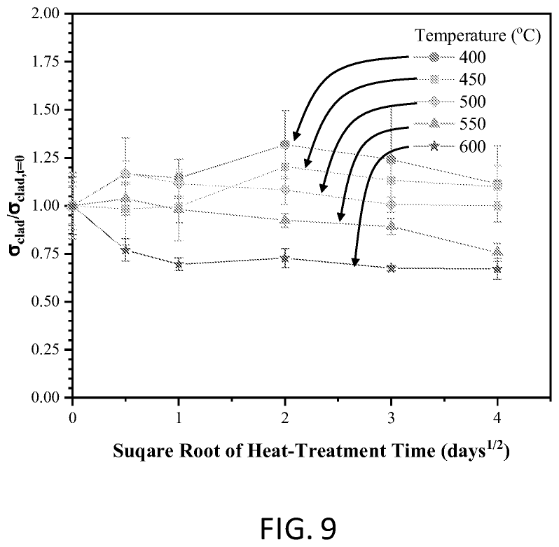

To demonstrate the present technology, laminate 700 was reproduced five times (i.e. five separate samples), and heat-treated at 5 temperatures: 400° C., 450° C., 500° C., 550° C., and 600° C. for 15 days each. Scattered light polariscope (SCALP) was used to measure stress prior to the heat-treatments. Each SCALP measurement is the average and standard deviation of 4-6 measurements at locations on the sample (e.g., locations in center of each quadrant). Then the samples were successively heat-treated with time, removed from the furnace, allowed to cool in air, and stress was measured by SCALP at each step. FIG. 9 is a plot of the ratio of clad stress relative to initial clad stress on the Y-axis versus time on the X-axis, in units of square root of days undergoing the heat treatment.

As shown in FIG. 9, stress in the Clad glass increased, at least initially, with heat treatment at all temperatures except 600° C. The highest ratio of compressive stress in the clad versus initial compressive stress occurred with 400° C. heat treatment for five days. After five days, the stress ratio decreased. For 450° C., the peak stress ratio also occurred after five days. For 500° C. and 550° C., the stress ratio increased initially, such as within the first 30 minutes, 60 minutes, couple hours, but then decreased from there. At 600° C., there was no increase in stress ratio, only decrease in compressive stress of the Clad glass.

Notably, the temperatures that lead to increase in the stress ratio were below the 929° C. softening point of the clad glass, such as over 100° C. less, such as over 200° C. less, such as over 300° C. less. Further the temperatures that lead to increase in the stress ratio were below the glass transition temperature, To₀ (° C.) of the Clad of 678.4° C. of the clad glass, such as over 100° C. less, such as over 200° C. less, such as over 300° C. less; and similarly below 200-Poise temperature, 35 kP-tempeature, and 200 kP-temperature of the Clad. Likewise the heat-treatment temperatures that lead to greatest increases in Clad stress were below the softening point of the Core glass, below 200-Poise temperature, 35 kP-tempeature, and 200 kP-temperature of the Core glass, and in some instances below the T₀ (° C.) of the Core glass, which as 460.8° C., such as over 100° C. less, such as over 200° C. less, such as over 300° C. less than those threshold temperatures.

The magnitude of compressive stress in the cladding 104a, 104b, 204, 304, 404 of articles 100, 200, 300, 400 as disclosed herein may be controlled by the relative thickness of the glass portion 102, 202, 302, 402 compared to the cladding 104a, 104b, 204, 304, 404, the difference in responsiveness to changes in fictive temperature between the glass portion 102, 202, 302, 402 and the cladding 104a, 104b, 204, 304, 404, and also the starting or initial fictive temperatures and corresponding density of the glass portion 102, 202, 302, 402. Accordingly, thicker glass portions 102, 202, 302, 402, with higher responsiveness in change of fictive temperature, transitioning from a higher fictive temperature will result in greater compressive stress of the cladding 104a, 104b, 204, 304, 404, other factors being equal.

According to an aspect of the present disclosure, for articles 100, 200, 300, 400 compressive stress in the cladding 104a, 104b, 204, 304, 404 after heat-treatment from strengthening via the presently disclosed technology may be at least 5 MPa, such as at least 10 MPa, such as at least 20 MPa, such as at least 30 MPa, such as at least 50 MPa, such as at least 100 MPa, such as at least 200 MPa, such as at least 300 MPa, such as at least 500 MPa, such as at least 1 GPa, such as at least 2 GPa, such as at least 3 GPa, such as at least 5 GPa, and/or no more than 10 GPa, such as no more than 5 GPa, such as no more than 2 GPa, such as no more than 1 GPa. Tensile stress in the glass portions 102, 202, 302, 402 after heat—treatment from strengthening via the presently disclosed technology may be at least 5 MPa, such as at least 10 MPa, such as at least 20 MPa, such as at least 30 MPa, such as at least 50 MPa, such as at least 100 MPa, such as at least 200 MPa, such as at least 300 MPa, such as at least 500 MPa, such as at least 1 GPa, such as at least 2 GPa, such as at least 3 GPa, such as at least 5 GPa, and/or no more than 10 GPa, such as no more than 5 GPa, such as no more than 2 GPa, such as no more than 1 GPa.

Timing of the heat-treatment for articles 100, 200, 300, 400 as disclosed herein may be adjusted so that the compressive stress in the cladding 104a, 104b, 204, 304, 404 is below a frangibility limit of the cladding, where fracture of the glass releases stored energy in the glass, causing the glass to break in multiple parts (e.g., more than 3 different pieces) with the initial crack bifurcating, and where (if unrestrained) small fractured pieces of the glass may eject. It may be undesirable in certain applications for the articles 100, 200, 300, 400 to be above the frangibility limit, so the heat-treatment can be timed so that the articles 100, 200, 300, 400 are below, but less than 200 MPa below the frangibility limit; such as below, but less than 100 MPa below the frangibility limit; such as below, but less than 50 MPa below the frangibility limit; such as below, but less than 20 MPa below the frangibility limit.

Applicants contemplate that articles 100, 200, 300, 400 may be made with glass portions 102, 202, 302, 402 and cladding 104a, 104b, 204, 304, 404 that are actually the same composition and both are glass, but where the glass portions 102, 202, 302, 402 initially are at higher fictive temperatures and have a correspondingly lesser density than the cladding 104a, 104b, 204, 304, 404, and during heat-treatment the glass portions 102, 202, 302, 402 shrink more than the cladding 104a, 104b, 204, 304, 404. Or, as discussed with respect to FIG. 4, where the article 400 may be heat-treated in a way that shrinks the glass portion 404 more than the cladding 402.

While the article 700 was made as discussed above, Applicants contemplate that a duel-fusion isopipe may be a useful way to make glass-to-glass laminates as disclosed herein. Two separate molten glasses flow from the isopipe to overlap one another and form a glass ribbon that is typically a clad-core-clad type configuration (see FIG. 1), which may then be cut into sheets. Alternatively, glasses as disclosed herein can be molded together, rolled, float-formed, or otherwise formed to make articles 100, 200, 300, 400.

Construction and arrangements of the compositions, structures, assemblies, and structures, as shown in the various aspects, are illustrative only. Although only a few examples of the aspects have been described in detail in this disclosure, modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. The order or sequence of any process, logical algorithm, or method steps may be varied or re-sequenced according to alternative embodiments. Other substitutions, modifications, changes and omissions may also be made in the design, operating conditions and arrangement of the various aspects without departing from the scope of the present inventive technology.

1.-12. (canceled)

13. A method of making a strengthened glass-based article, comprising:
rapidly cooling molten glass;
bonding the glass to a cladding;
heating the glass to a temperature greater than 100° C. and below a softening temperature of the glass, while bonded to the cladding, to increase density of the glass by at least 10 mg/cm³, and
imparting compressive stress on the cladding during heating by compacting the glass bonded thereto, pulling the cladding into compression.

14. The method of claim 13, wherein the rapidly cooling is such that temperature of the molten glass decreases by at least 300° C. in less than 2 minutes.

15. The method of claim 13, wherein the rapidly cooling is such that the molten glass, once solidified, has a fictive temperature of at least 600° C.

16. The method of claim 13, wherein the temperature is above 200° C.

17. The method of claim 16, wherein the compacting further comprises keeping the glass at or above the temperature for at least an hour in aggregate.

18. The method of claim 16, wherein prior to the heating the glass is below 50° C.

19.-30. (canceled)
